(19) United States
(12) Patent Application Publication
(10) Pub. No.: US 2006/0021042 A1
(43) Pub. Date: Jan. 26, 2006

(54) Device for Internet-worm treatment and system patch using movable storage unit, and method thereof

(76) Inventors: Yang Seo Choi, Daejeon-city (KR); Dong Il Seo, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/971,978

(22) Filed: Oct. 22, 2004

(30) Foreign Application Priority Data
Jul. 23, 2004 (KR) 2004-57635

(51) Int. Cl. G06F 12/14

(52) U.S. Cl. 726/24

(57) ABSTRACT

A device for an Internet-worm treatment and a system patch using a movable storage unit is provided. The device includes: the movable storage unit for storing an integral program and integrity verification information; a program initializing unit for confirming an integrity of the Internet-worm treatment and system patch program by using the integrity verification information; a system control unit for cutting off a performance of the Internet worm malfunctioning the computer system, in case where the integrity is verified by the program initializing unit; a server unit for storing recent patch information and Internet-worm information; a treatment-information acquiring unit for acquiring the recent patch information and Internet-worm information, which is not applied to the infected computer system, from the server unit; and a system restoring unit for receiving the recent patch information and Internet-worm information from the treatment-information acquiring unit and applying the received information to the program, to perform the Internet-worm treatment and the system patch for the computer system.

### BACKGROUND OF THE INVENTION

1. Field of the Invention

The present invention relates to a device for an Internet-worm treatment and a system patch using a movable storage unit and a method thereof, and more particularly, to a device and method in which Internet worm infecting a computer system is treated and a prompt patch is automatically performed for a corresponding vulnerable point of the computer system, by using a movable storage unit that can be simply and conveniently carried.

2. Description of the Related Art

A conventional Internet-worm treatment method is performed as a general treatment of Internet worm and virus. That is, an Internet-worm definition file is retained and used for treatment prior to the infection of the Internet worm, to limit its encroachment itself. Accordingly, in case where a new Internet worm, which is not defined in the Internet-worm definition file, is created to infect a computer system, the Internet worm cannot be cut off or the computer system cannot be protected. Further, in case where the new Internet worm infects the computer system, it is difficult to obtain information necessary for the treatment of the new Internet worm since the computer system is repeatedly rebooted for a short time or cannot utilize a network resource. Therefore, there is a drawback in that it takes a long time, especially for a general user, not a specialist, to treat the Internet worm and restore the infected computer system, thereby greatly falling down availabilities of the computer system and a network.

### SUMMARY OF THE INVENTION

Accordingly, the present invention is directed to a device for an Internet-worm treatment and a system patch using a movable storage unit and a method thereof, which substantially obviate one or more problems due to limitations and disadvantages of the related art.

It is an object of the present invention to provide a device for an Internet-worm treatment and a system patch using a movable storage unit and a method thereof in which in case where a computer system is infected by Internet worm or virus, all processes are stopped except a treatment process for a corresponding infected computer system and a process for a system operation, only the treatment process is allowed to utilize a network resource, and necessary Internet-worm information and system patch information are used to promptly and automatically restore the computer system after the confirmation of system patch information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a device for an Internet-worm treatment and a system patch using a movable storage unit, the device including: the movable storage unit for storing an integral program, which performs the Internet-worm treatment and the system patch in a computer system, and integrity verification information created when the integral program is initially installed in the computer system; a program initializing unit for confirming an integrity of the Internet-worm treatment and system patch program, which is automatically driven in case where the computer system is infected by Internet worm, by using the integrity verification information provided from the movable storage unit; a system control unit for cutting off a performance of the Internet worm malfunctioning the computer system, in case where the integrity is verified by the program initializing unit; a server unit for storing recent patch information and Internet-worm information according to an operating system of the computer system; a treatment-information acquiring unit for acquiring the recent patch information and Internet-worm information, which is not applied to the infected computer system, from the server unit; and a system restoring unit for receiving the recent patch information and Internet-worm information from the treatment-information acquiring unit and applying the received information to the program, to perform the Internet-worm treatment and the system patch for the computer system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a device for an Internet-worm treatment and a system patch according to the present invention; and

FIGS. 2A and 2B are flowcharts illustrating a method for an Internet-worm treatment and a system patch according to the present invention.

### DETAILED DESCRIPTION OF THE INVENTION

Reference will now be made in detail to the preferred embodiments of the present invention, examples of which are illustrated in the accompanying drawings.

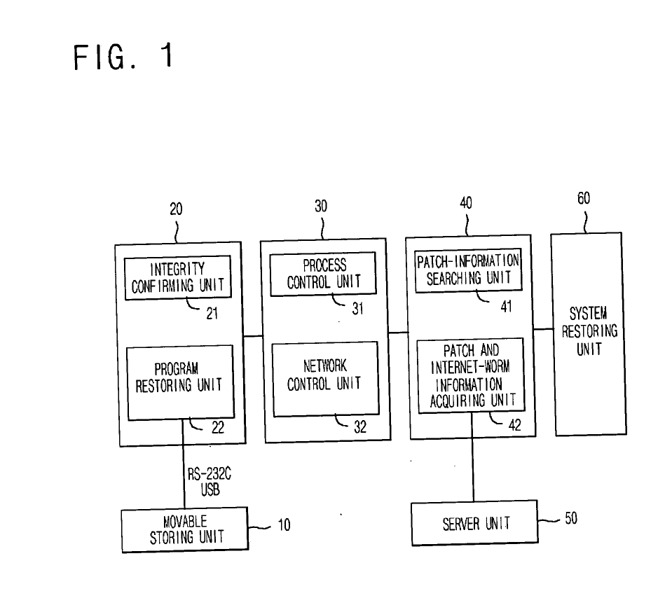

FIG. 1 is a block diagram illustrating a device for an Internet-worm treatment and a system patch according to the present invention.

As shown in FIG. 1, the inventive device for the Internet-worm treatment and the system patch includes a movable storage unit 10; a program initializing unit 20; a system control unit 30; a treatment-information acquiring unit 40; a server unit 50; and a system restoring unit 60.

The movable storage unit 10 stores an Internet-worm treatment and system patch program initially installed in the program initializing unit 20, and an integrity verification information using various information created when the Internet-worm treatment and system patch program is installed. The movable storage unit 10 is write-protected to prevent a damage due to the Internet worm.

Additionally, in case where the Internet worm infects a general computer system, the program initializing unit 20 confirms the integrity of the Internet-worm treatment and system patch program, which is previously stored and automatically driven in the computer system. At this time, in case where the integrity is maintained, the Internet-worm treatment and system patch program initiates the Internet-worm treatment. In case where the integrity is encroached, a program code stored in the movable storage unit 10 with the integrity being ensured is downloaded to initiate the Internet-worm treatment.

The program initializing unit 20 includes an integrity confirming unit 21 and a program restoring unit 22. The integrity confirming unit 21 confirms the integrity of the Internet-worm treatment and system patch program. That is, after the Internet-worm treatment and system patch program is first installed in a general personal computer, the integrity confirming unit 21 confirms whether or not the program is infected, that is, whether or not the program is integral, by using integrity information created on the basis of a size, an installation date and time, an installation position, a user password and the like of the program. At this time, the integrity information is stored and preserved in the movable storage unit 10. When the program integrity is confirmed, the integrity information is read and used.

Additionally, in case where the integrity of the Internet-worm treatment and system patch program installed in the system is encroached, that is, in case where the integrity information is infected by the Internet worm or virus, the program restoring unit 22 reinstalls all of the program from the movable storage unit 10, or reads a necessary portion of the program to again restore the program, thereby ensuring a program reliability.

The system control unit 30 cuts off the infection of the Internet worm in the computer system malfunctioning due to the Internet worm. The system control unit 30 includes a process control unit 31 and a network control unit 32. The process control unit 31 stops an unnecessary process in the infected computer system. The network control unit 32 controls a packet, which is transmitted and received through a network, to stably utilize the network and cut off a malicious network packet caused by the Internet worm.

In other words, the process control unit 31 stops all processes except a previously defined main process of an operating system. This is performed using a main process list, which is defined according to the operating system determined when the program is installed in the computer system.

The network control unit 32 controls to once cut off a network packet transmitted and received through all communication units (network card, modem and the like) available in the computer system. The network control unit 32 controls to enable only a network communication in which a patch and Internet-worm information acquiring unit 42 is connected to a safe server unit 50 to acquire patch and Internet-worm information, thereby assuring an availability of the network. This is performed not at an application program, but at a kernel of the operating system. Therefore, the malicious packet caused by the Internet worm operating in the application program can be effectively cut off.

Additionally, the treatment-information acquiring unit 40 first confirms the patch information of the infected computer system, and downloads recent patch information and recent Internet-worm definition information, which are not currently applied to the infected computer system, from the safe server unit 50 by using the confirmed patch information. The treatment-information acquiring unit 40 includes a patch-information searching unit 41 and the patch and Internet-worm information acquiring unit 42.

The patch-information searching unit 41 collects the patch information applied to the infected computer system. The patch and Internet-worm information acquiring unit 42 downloads the recent patch information and Internet-worm definition information, which are not currently applied to the infected computer system, from the safe server unit 50 by using the collected patch information. This can be performed using the network communication because the network control unit 32 sets only the patch and Internet-worm information acquiring unit 42 to use the network.

Additionally, only in case where a specific verification procedure is performed, the server unit 50 is operated to permit access, thereby preventing a general Internet-worm access. The server unit 50 manages a recent patch situation and the recent Internet-worm information at each operating system of the computer system.

Additionally, the system restoring unit 60 searches for and eliminates the Internet worm existing at the computer system by using the patch and Internet-worm information acquired through the patch and Internet-worm information acquiring unit 42 of the treatment-information acquiring unit 40. The system restoring unit 60 applies the patch information to the computer system such that the computer system is prevented from being again infected due to the same vulnerable point by the Internet worm. If the Internet-worm treatment and the patch are completed as described above, the network control unit 32 of the system control unit 30 undoes a use limit of the network and returns to an original state. The above Internet-worm treatment is performed in the same way as a conventional Internet-worm treatment program, and a patch application is performed in the same way as a general patch file application.

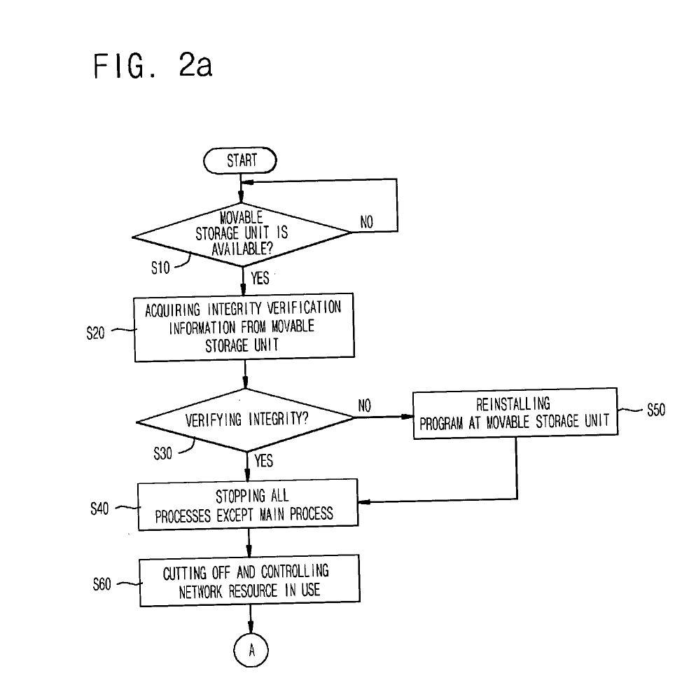

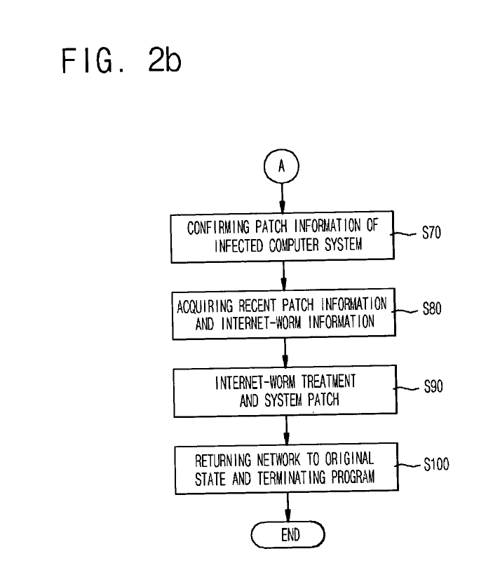

FIGS. 2A and 2B are flowcharts illustrating a method for the Internet-worm treatment and the system patch according to the present invention.

As shown in FIGS. 2A and 2B, first, the program initializing unit 20 confirms whether or not the movable storage unit 10 is available (S10). If it is confirmed that the movable storage unit 10 is available, the integrity confirming unit 21 acquires the integrity verification information from the movable storage unit 10 (S20), and uses the acquired integrity verification information to confirm the integrity of the Internet-worm treatment and system patch program installed in the infected computer system (S30). At this time, in case where the integrity is verified, the process control unit 31 stops all processes except the main process of the infected computer system (S40). However, if the integrity verification is failed, the program restoring unit 22 reinstalls a reliable and safe Internet-worm treatment and system patch program, which is stored in the movable storage unit 10, in the system (S50), and then all processes are stopped except the main process of the infected computer system.

Next, the network control unit 32 controls to once cut off all network packets transmitted/received in the infected computer system and cut off the network resource in use, thereby limitedly operating the network resource (S60).

After that, the patch-information searching unit 41 searches for and acquires various patch information applied to the infected computer system (S70). The patch and Internet-worm information acquiring unit 42 connects to the server unit 50 to confirm the patch information not currently applied to the infected computer system by using the patch information, which is acquired from the patch-information searching unit 41, of the infected computer system (S80).

Accordingly, the system restoring unit 60 applies the patch information and Internet-worm information, which is acquired from the treatment-information acquiring unit 40, to the Internet-worm treatment and system patch program to perform the Internet-worm treatment and the system patch (S90).

After that, if the system restoration is completed, a network function, which is cut off by the network control unit 32, is returned to the original state, and the program is terminated (S100).

The inventive method for the Internet-worm treatment and the system patch can be computer-programmed and stored in a recording medium such as a hard disk, a floppy disk, an optical magnetic disk, CD-ROM, ROM, RAM and the like.

As described above, in case where the Internet worm or virus infects the computer system, the present invention confirms the patch information of the computer system, and then acquires necessary Internet-worm information and system patch information to promptly and automatically restore the computer system. Therefore, even a non-professional user without a professional knowledge for the Internet worm and virus can promptly restore the infected computer system in a reliable, safe and automatic method.

Further, the present invention has an effect in that a network-available process is limited to prevent an avalanche of the network packets from being generated in the network, thereby miniaturizing a damage caused by the avalanche. Therefore, the present invention can prevent a conventional Internet-worm treatment technology from being limited to the Internet-worm information of the Internet-worm or virus treatment program. Further, the present invention has an effect in that a fundamental drawback is solved using the patch to prevent a repetitive infection caused by the same Internet-worm.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A device for an Internet-worm treatment and a system patch using a movable storage unit, the device comprising:
the movable storage unit for storing an integral program, which performs the Internet-worm treatment and the system patch in a computer system, and integrity verification information created when the integral program is initially installed in the computer system;
a program initializing unit for confirming an integrity of the Internet-worm treatment and system patch program, which is automatically driven in case where the computer system is infected by Internet worm, by using the integrity verification information provided from the movable storage unit;
a system control unit for cutting off a performance of the Internet worm malfunctioning the computer system, in case where the integrity is verified by the program initializing unit;
a server unit for storing recent patch information and Internet-worm information according to an operating system of the computer system;
a treatment-information acquiring unit for acquiring the recent patch information and Internet-worm information, which is not applied to the infected computer system, from the server unit; and
a system restoring unit for receiving the recent patch information and Internet-worm information from the treatment-information acquiring unit and applying the received information to the program, to perform the Internet-worm treatment and the system patch for the computer system.

2. The device of claim 1, wherein the integrity verification information is created on the basis of a size, an installation date and time, an installation position, and a user password of the Internet-worm treatment and system patch program.

3. The device of claim 1, wherein the program initializing unit comprises:
an integrity confirming unit for receiving the integrity verification information from the movable storage unit to confirm an integrity of an Internet-worm treatment and system patch program initially installed in the computer system; and
a program restoring unit for receiving an integrity-assured program from the movable storage unit when the initially installed program is encroached in integrity, to reinstall the integrity-assured program or again restore the initially installed program.

4. The device of claim 1, wherein the system control unit comprises:
a process control unit for stopping all processes except a previously defined main process of an operating system and an Internet-worm treatment and system patch process, among all processes performed in the infected computer system; and
a network control unit for controlling to once cut off all network packets, which are transmitted/received through a communication unit of the infected computer system, and to enable only a network communication for acquiring the recent Internet-worm information and system patch information.

5. The device of claim 1, wherein the treatment-information acquiring unit comprises:
a patch-information searching unit for acquiring the patch information applied to the infected computer system; and
a patch and Internet-worm information acquiring unit for confirming the acquired patch information to download the recent patch information and the recent Internet-worm information, which is not applied to the infected computer system, from the server unit.

6. A method for an Internet-worm treatment and a system patch using a movable storage unit, the method comprising the steps of:
(a) confirming an integrity of an Internet-worm treatment and system patch program, which is driven in case where a computer system is infected by Internet worm;
(b) in case where the program is verified in integrity, stopping all processes except a process of the integrity-verified program and a process of an operating-system;
(c) cutting off a use of a network resource of all communication units, except a network resource for acquiring recent Internet-worm information and patch information;
(d) confirming various patch information applied to the infected computer system to receive the recent patch information and Internet-worm information not applied to the infected computer system; and
(e) applying the acquired patch information and Internet-worm information to the Internet-worm treatment and system patch program to perform an Internet-worm treatment and a system patch.

7. The method of claim 6, wherein in the (a) step, the integrity of the program is confirmed through the confirmation of an integrity verification information created when the program is initially installed.

8. The method of claim 6, further comprising the step of: in case where the integrity of the program is not verified in the (a) step, providing and reinstalling an integrity-assured program from the movable storage unit connected with the computer system.
